(19) United States
(12) Patent Application Publication
(10) Pub. No.: US 2025/0309521 A1
(43) Pub. Date: Oct. 2, 2025

(54) HYBRID ANTENNA FOR BIOMETRIC INSERT, CORE LAYER AND INFORMATION CARRYING CARD COMPRISING THE SAME

(71) Applicant: SentryCard Technologies, Inc., Chicago, IL (US)

(72) Inventor: Mark Cox, West Chester, PA (US)

(21) Appl. No.: 19/091,345

(22) Filed: Mar. 26, 2025

Related U.S. Application Data
(60) Provisional application No. 63/570,967, filed on Mar. 28, 2024.

(51) Int. Cl. H01Q 1/22; B32B 3/08; B32B 7/12; B32B 27/30; H01Q 7/00

(52) U.S. Cl. CPC H01Q 1/2208; B32B 3/08; B32B 3/085; B32B 7/12; B32B 27/304; H01Q 7/00; B32B 2250/24; B32B 2255/10; B32B 2255/26; B32B 2307/412; B32B 2307/75; B32B 2425/00; B32B 2457/00; B32B 2519/02

(57) ABSTRACT

The present disclosure provides a core sheet, a core layer comprising the core sheet for an information carrying card, an information carrying card comprising the same, and the methods of making the core sheet, the core layer, and the information carrying card. The core sheet includes a substrate film such as a thermoplastic film, and an antenna structure disposed on or embedded within the substrate film. The antenna structure includes a wire made of a conductive material and comprises a first antenna portion including a first number of loops and configured to communicate with a first RF frequency. The antenna structure further includes a second antenna portion including at least one portion having a waveform structure.

### PRIORITY CLAIM AND CROSS-REFERENCE

This application claims the benefit of U.S. Provisional Application No. 63/570,967, filed Mar. 28, 2024, which application is expressly incorporated by reference herein in its entirety.

### FIELD OF THE INVENTION

The disclosure relates to information carrying cards such as smart cards generally. More particularly, the disclosed subject matter relates to an antenna structure, a core layer comprising the antenna structure, a resulting product comprising the core layer, the resulting information carrying cards, and the methods of making the same.

### BACKGROUND

Information carrying cards provide identification, authentication, data storage and application processing. Such cards or parts include key cards, identification cards, telephone cards, credit cards, bankcards, tags, bar code strips, other smart cards and the like. Counterfeiting and information fraud associated with traditional plastic cards causes tens of billions of dollars in the losses each year. As a response, information carrying cards are getting “smarter” to enhance security. Smart card technologies provide solutions to prevent fraud and decrease resulting losses.

Information carrying cards often include an integrated circuit (IC) embedded in a thermoplastic material, such as polyvinyl chloride (PVC). Information has been input and stored in the integrated circuit before a transaction. In use, information carrying cards work in either a “contact” or “contactless” mode. In contact mode, an electronic component on the card is caused to directly contact a card reader or other information receiving device to establish an electromagnetic coupling. In contactless mode, the electromagnetic coupling between the card and the card reading device is established through electromagnetic action at a distance, without the need for physical contact. The process of inputting information into the IC of the information carrying card also works in either of these two modes.

When information carrying cards become “smarter,” the amount of information stored in each card often increases, and the complexity of the embedded IC's also increases. The cards also need to withstand flexing to protect sensitive electronic components from damage as well as offer good durability during use. In most of the existing technologies, as a final product, a card is made directly on a card body through a process such as injection molding, bonding, embedding, and encapsulation, in which electronic components are attached or mounted onto the card body or into a cavity on the card body. Such a cavity may have a size the same as or similar to the size of an inlay having the electronic components. Such existing methods can be seen in patents or published patent applications, for example, U.S. Pat. Nos. 5,520,863; 6,902,116; 8,012,809; US 2005/0006463; US 2006/0227523; US 2010/0226107; US 2010/0270373; and US 2012/0103508. The existing processes do not offer a large-scale manufacturing capability, and may not be suitable for sensitive components. It is desired to have a relatively easy and full-scale commercial process having improved productivity at low cost and offering products with good quality and durability.

Radiofrequency identification (RFID) technology harnesses electromagnetic fields to transfer data wirelessly. One of the primary uses for RFID technology is the automatic identification and tracking of objects via RFID tags, which may be attached or incorporated into a variety of objects. Examples include credit cards, passports, license plates, identity cards, cellphones/mobile devices, etc. RFID technology also has applications in numerous areas, including, but not limited to, electronic tolling, parking access, border control, payment processing, asset management, and transportation. Thus, for example, a license plate that includes an RFID tag may be used for the purposes of electronic toll collection (ETC), electronic vehicle registration (EVR), border crossing etc.

Radio-frequency identification (RFID) is a remote recognition technique that utilizes RFID tags having information stored therein, usually in an integrated circuit (IC). The stored information is retrievable via RF communication between the RFID tag and an RFID tag reader. Certain RFID systems utilize hand-held RFID readers that when brought sufficiently close to an RFID tag are able to read an RFID tag signal either emitted by or backscattered from the tag. RFID systems are used for a variety of applications, including inventory management and product tracking in a number of different industries, as well as in libraries and hospitals.

RFID tags generally come in three varieties: passive, semi-passive, and active. Passive RFID tags have no energy or power source of their own and operate by harvesting energy from the RF signal (field) generated by the RFID-tag reader. Passive tags communicate back to the reader by modulating and back-scattering the RF signal from the RF reader. Semi-passive RFID tags communicate to the reader in the same way via modulation of the backscattered reader RF signal, but they do not rely on harvesting energy from the reader field to power the RFID tag IC. Instead, semi-passive tags generally have their own power source, usually in the form of one or more batteries. Since the amount of power harvested by a passive tag usually limits its maximum distance from the reader antenna, semi-passive RFID tags usually have significantly greater read ranges than passive tags. Active tags also have a power source such as a battery that not only powers the RFID tag IC but that can also actively generate and transmits radiation to the RFID reader.

RFID tags can be designed to operate at different RF frequencies. At low frequencies (e.g., 100-130 KHz) RFID tags often communicate via mutual inductance coupling between an RFID-reader coil antenna and an RFID-tag coil antenna. At these frequencies, the RFID reader's RF signal is not strongly absorbed by water. Since the user's hand is primarily composed of water, this means that at low RF frequencies the RF signal can penetrate the user's hand and enable two-way communication between the RFID tag and the RFID reader.

RFID tags designed to operate at higher frequencies (e.g., ultra-high frequencies of 900 MHz or greater) typically operate by the RFID tag capturing far-field radiation from the RFID reader antenna transmission using a local monopole, dipole or modified dipole antenna. Ultra-high-frequency RFID tags can communicate with RFID readers at much greater read distances (e.g., 5 to 10 m) than low frequency RFID tags (1 m or less). Ultra-high-frequency RFID tags are thus better suited for applications involving the RFID identification of hand-held items. A problem with using ultra-high frequency RFID tags for the identification of hand-held items arises due to the strong absorption of high-frequency RF signal power by water.

It is desired to produce information carrying cards configured to work well at high frequencies, i.e., between the low frequencies and the ultra-high frequencies, particularly with cell phones.

### SUMMARY OF THE INVENTION

The present disclosure provides a core sheet comprising an antenna structure, a core layer comprising the core sheet for one or a plurality of information carrying cards, a resulting information carrying card, and the methods of making the core sheet, the core layer, and the information carrying card.

The core sheet includes a substrate film, and an antenna structure disposed on or embedded within the substrate film. The antenna structure includes a wire made of a conductive material and comprises a first antenna portion including a plurality of loops. The first antenna portion is configured to communicate with a first RF frequency. The antenna structure further includes a second antenna portion including at least one portion having a waveform structure. The portion having the wave structure may be in one or more of the loops. The number of the loops in total includes the loops without the waveform structure and those with the waveform structure. The waveform structure is configured to communicate with a second RF frequency and utilize eddy current from an external device to power the information carrying card. The second RF frequency is higher than the first RF frequency.

The core sheet further comprises at least one integrated circuit (or chip or chips) disposed on or embedded on the first thermoplastic layer, and electrically connected with the antenna structure. The substrate film comprises a polymer, a paper, plasticized paper, a composite, or any combination thereof.

In some embodiments, the first antenna portion and the second antenna portion are connected and may be made of one metal wire. In some embodiments, the metal wire is made of copper or copper alloy. In some embodiments, the conductive material are printed on the substrate film such as a thermoplastic layer.

In some embodiments, the antenna structure and the at least one integrated circuit are connected by laser melting of the conductive material or by a conductive tape.

In another aspect, the present disclosure provides a core layer for one or a plurality of information carrying cards, comprising one or a plurality of core sheets as described herein.

In some embodiments, the core layer comprises a crosslinked polymer disposed on both side of the core layer. In some embodiments, the core layer is self-centered in the crosslinkable polymer, the precursor of the crosslinked polymer, before and during curing in a thermal lamination process under a temperature and a pressure. In such a method, a crosslinkable polymer in a liquid or paste form is applied to both sides of the core sheet in a mold for thermal lamination. The mold includes a height adjustment edges to define the thickness. During a curing process at a low temperature and under a pressure, the core sheet self-centers in the mold with the help of the crosslinkable polymer.

In some embodiments, the core layer includes a plurality of section and is configured to be for a plurality of information carrying cards. Each section comprises one antenna structure.

In another aspect, the present disclosure provides an information carrying card comprising the core sheet or the core layer as described herein.

In another aspect, the present disclosure provides a method of making the core sheet as described herein. In another aspect, the present disclosure provides a method of making the core layer as described herein.

In another aspect, the present disclosure provides a method of making one or a plurality of the information carrying cards as described herein.

The antenna structure is configured to resonate at high frequency (called a resonating frequency), for example, in a range of from 12 MHz to 21 MHz or even higher. The resonating frequency of the antenna structure can be adjusted to any suitable number by changing the antenna design, and can be tailored based on the applications. For example, for some uses of an information carrying card, the antenna is designed for power generation and communication. The antenna structure is configured to resonate at a frequency in the range of from 13 MHz to 18 MHz such as from 13 MHz to 14 MHz or equal to or close to 13.56 MHz as defined by the ISO/IEC 14443 standard. In some embodiments, the antenna structure may be used for power generation only, and is configured to resonate at a frequency in a range of from 18 MHz to 21 MHz. The antenna structure provides good performance and design flexibility. The resulting products including the core layer and the information carrying card provide flexibility and other mechanical properties, environmental (such as moisture) resistance, and more functions. Mass production of these products can be achieved at reduced cost.

### BRIEF DESCRIPTION OF THE DRAWINGS

The present disclosure is best understood from the following detailed description when read in conjunction with the accompanying drawings. It is emphasized that, according to common practice, the various features of the drawings are not necessarily to scale. On the contrary, the dimensions of the various features are arbitrarily expanded or reduced for clarity. Like reference numerals denote like features throughout specification and drawings.

FIG. 1A illustrates an exemplary core sheet comprising a first exemplary antenna structure in accordance with some embodiments.

FIG. 1B is a magnified view of the first exemplary antenna of FIG. 1A.

FIG. 2A illustrates an exemplary core sheet comprising a second exemplary antenna structure in accordance with some embodiments.

FIG. 2B is a magnified view of the second exemplary antenna of FIG. 2A.

FIG. 3 illustrates an exemplary core sheet comprising a third exemplary antenna structure in accordance with some embodiments.

FIG. 4 illustrates an exemplary core sheet comprising a fourth exemplary antenna structure in accordance with some embodiments.

FIG. 5A illustrates an exemplary core sheet comprising a fifth exemplary antenna structure in accordance with some embodiments.

FIG. 5B is a magnified view of the exemplary antenna of FIG. 5A.

FIG. 6 illustrates a sixth exemplary antenna structure in accordance with some embodiments.

FIG. 7 illustrates an exemplary core sheet comprising a seventh exemplary antenna structure in accordance with some embodiments.

FIG. 8A illustrates an exemplary core sheet comprising an eighth exemplary antenna structure in accordance with some embodiments.

FIG. 8B is a magnified view of the exemplary antenna of FIG. 8A.

FIGS. 9A-9D illustrates four exemplary core sheets each comprising different exemplary antenna structure having two portions having waveforms in accordance with some embodiments.

FIGS. 10A-10B illustrate comparison between one exemplary antenna structure and one comparative antenna structure.

FIGS. 10C-10D illustrate comparison between another exemplary antenna structure and another comparative antenna structure.

FIG. 11 illustrates an exemplary core layer for an information carrying card in accordance with some embodiments.

FIG. 12 is a sectional view illustrating a substrate such as a thermoplastic layer, a paper or any other suitable film in accordance with some embodiments.

FIG. 13 is a sectional view illustrating an exemplary core sheet comprising an exemplary antenna structure, which can be at least partially embedded in the substrate in accordance with some embodiments.

FIG. 14 is a sectional view illustrating an exemplary core sheet comprising an exemplary antenna structure, which can be disposed on the substrate in accordance with some embodiments.

FIG. 15 is a sectional view illustrating an exemplary core (or core layer) for a plurality of information carrying cards in a manufacturing process, in which a crosslinkable polymer composition are applied to both sides of a core sheet, in accordance with some embodiments.

FIG. 16 is a sectional view illustrating an exemplary core (or core layer) for a plurality of information carrying cards comprising a crosslinked polymer composition on both sides of a core sheet, in accordance with some embodiments.

FIG. 17 is a plan view illustrating the exemplary core (or core layer) of FIG. 11.

FIG. 18 is a sectional view illustrating a plurality of information carrying cards being made in accordance with some embodiments.

FIG. 19 is a section view illustrating an information carrying card after a step of cutting from the plurality of information carrying cards shown in FIG. 18. The dimensions are not based on the actual scale, and the drawings are for the purpose of illustration only.

FIG. 20 is a flow chart illustrating an exemplary method of making a core layer for a plurality of information carrying card in accordance with some embodiments.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

For purposes of the description hereinafter, it is to be understood that the embodiments described below may assume alternative variations and embodiments. It is also to be understood that the specific articles, compositions, and/or processes described herein are exemplary and should not be considered as limiting.

In the present disclosure the singular forms “a,” “an,” and “the” include the plural reference, and reference to a particular numerical value includes at least that particular value, unless the context clearly indicates otherwise. When values are expressed as approximations, by use of the antecedent “about,” it will be understood that the particular value forms another embodiment. As used herein, “about X” (where X is a numerical value) preferably refers to +10% of the recited value, inclusive. For example, the phrase “about 8” preferably refers to a value of 7.2 to 8.8, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

The present disclosure provides a core sheet, a core layer comprising the core sheet for one or a plurality of information carrying cards, a resulting information carrying card or a plurality of information carrying cards, and the methods of making the core sheet, the core layer, and the information carrying card. The present disclosure also provides the methods of making the core sheet, the core layer, and the information carrying card.

Unless expressly indicated otherwise, references to “low frequency” made below will be understood to encompass a frequency at kHz to MHz level, but less than 10 MHz. sometimes, a frequency less than 14 MHz used in RFID is referred as a low frequency.

Unless expressly indicated otherwise, references to “high frequency” made below will be understood to encompass a frequency above 10 MHz level, especially above 14 MHz, for example, from 15 MHz to 50 MHz, or from 15 MHz to 20 MHz.

References to “ultra-high frequency” made below will be understood to encompass a frequency above 900 MHz level.

References to “a waveform structure” as described herein refers to a portion of a loop in an antenna structure, having a regular or periodic pattern similar to a wave or modified wave. The wave structure has a maximum height and a minimum height. Examples of the shape of such a waveform structure include, but are not limited to, sine wave, square wave, rectangular wave, triangular wave, sawtooth wave, or any combination thereof. The square wave and rectangular wave forms are also referred as “block” shape. The sine wave is also called sinuous shape.

The term “resonating frequency” used herein refers to the frequency, which an antenna structure resonates with or tunes to. The resonating frequency was measured using a Vector Network Analyzer (VNA) when the antenna was unloaded.

The antenna structure as described herein is made of a conductive material such as a metal wire, and includes a number of turns or loops. The conductive material is copper or copper alloy in some embodiments. The metal wire may be coated with a polymer coating or embedded in the thermoplastic layer. The antenna structure include turns or loops. Some turns or loops also include a portion having the waveform structure. The metal wire among different loops are insulated from one another.

The antenna structure is configured to resonate at a high resonating frequency, for example, in a range of from 12 MHz to 21 MHz or even higher. The resonating frequency of the antenna structure can be adjusted to any suitable number by changing the antenna design, and can be tailored based on the applications. For example, for some uses of an information carrying card, the antenna is designed for power generation and communication. The antenna structure is configured to resonate at a frequency in the range of from 13 MHz to 18 MHz such as from 13 MHz to 14 MHz or equal to or close to 13.56 MHz as defined by the ISO/IEC 14443 standard. In some embodiments, the antenna structure may be used for power generation only, and is configured to resonate at a frequency in a range of from 18 MHz to 21 MHz. The antenna structure provides good performance and design flexibility. The resulting products including the core layer and the information carrying card provide flexibility and other mechanical properties, environmental (such as moisture) resistance, and more functions. Mass production of these products can be achieved at reduced cost.

One of the objectives of the present disclosure is to develop new antenna called alien antenna structure used in a core layer for an information carrying card or an information carrying card. The antenna structure comprises a first portion for low frequency RF and a second portion for high frequency RF. The antenna structures is configured to calm Eddy currents on mobile phones packaging and to improve performance and range of read for NFC. A core sheet or a core layer described herein comprising a plurality of sections. Each section comprises an antenna structure. Each section will correspond to an information carrying card. So each core layer or core sheet is for a plurality of information carrying cards.

In some embodiments, the antenna structure in the information carrying card is configured for both power generation and communication, especially for contactless application. Each card can generate power without using battery or other power source in a resulting information carrying card. The information carrying card is for power and communication. The card is similar to a smart card for communication and operates at a high frequency equal to or close to 13.56 MHz as defined by the ISO/IEC 14443 standard. This type of card is preferred in some applications in the present disclosure. The antenna structure is configured to tune to or resonate at a frequency equal to or close to 13.56 MHz, for example, in the range of from 13 MHz to 18 MHz such as from 13 MHz to 14 MHz. One of the most preferable frequency using these antennas may be 15.00-16.20 MHz. These target frequencies are different for differ use cases or environments.

In some other embodiments, the antenna structure in the information carrying cards is configured for power generation only. The antenna structure is configured to tune to or resonate at a higher frequency, for example, in a range of 18 MHz to 21 MHz.

The antenna structure in the present disclosure can be designed with flexibility for adjustable working frequency based on specific applications. The antenna structure utilizes simplified materials and design other than complicated components to achieve operability at different frequency. The antenna structure is configured to generate power when exposed to electromagnetic field. Therefore, no battery or other power source is needed in the resulting information carrying card.

The present disclosure also provides a core sheet comprising the antenna structure as described herein, a core or core layer for one or a plurality of information carrying cards comprising such antenna structures, and an information carrying card comprising the antenna structure as described herein.

In some embodiments, the information carrying card is a biometric smart card. The antenna structure are configured to inductively communicate with RF signals, for example, from a cell phone. The information carrying card are configured to communicate with the cell phone to provide biometric, personal, and/or financial information to the cell phone or verify these information with the cell phone. Meanwhile, the antenna structure in the information carrying card is also generate power for the operation of the information carrying card.

In accordance with some embodiments, the core sheet includes a first thermoplastic layer made of a thermoplastic polymer, and an antenna structure disposed on or embedded within the first thermoplastic layer. The antenna structure includes a wire made of a conductive material and comprises a first antenna portion including a first number of loops and configured to communicate with a first RF frequency. The antenna structure further includes a second antenna portion including at least one portion having a waveform structure. The waveform structure is configured to communicate with a second RF frequency and utilize eddy current from an external device to power the information carrying card. The second RF frequency is higher than the first RF frequency.

The core sheet further comprises at least one integrated circuit (or chip or chips) disposed on or embedded on the first thermoplastic layer, and electrically connected with the antenna structure.

In some embodiments, the first antenna portion and the second antenna portion are connected and made one metal wire. In some embodiments, the metal wire is made of copper or copper alloy. In some embodiments, the conductive material are printed on the thermoplastic layer.

In some embodiments, the antenna structure and the at least one integrated circuit are connected by laser melting of the conductive material or by a conductive tape.

After some research and development, the inventor has developed a new type of antenna for smart card application, for example, for a smart card having biometric inert. The antenna is a hybrid design including a more standard RF antenna (a first portion) mixed with a high frequency design antenna (a second portion). The second portion has at least one portion having a waveform structure. This antenna has proven to overcome the challenges of multi phone use for the card products and very producible in new industrial Prelam processes for these products. The antenna design is novel in its design and use, and also provides unexpected and surprisingly good results.

The antenna design as described herein allows the biometric insert to be used on the iPhone and all android based NFC equipped mobile phone, along with normal wall mounted and mobile readers. It produces enough energy and BAUD rate transfer for an ease of use, without different designs being needed for each phone style, as is currently being used. The design utilizes the high frequency eddy current on a mobile phone case as well as normal RFID signal to create a more forgiving and powerful antenna design. These solutions also may solve normal readers for security that are attached to metal, which limit the read range and expand the use of products with readers which are commonly miss installed. It also makes use by a consumer far easier, allowing market acceptance of the products.

Waveform size and the numbers play a key role in controlling the frequency.

Some examples of alien antenna designs are shown herein for the purpose of illustration. The designs are a hybrid of high frequency and normal RFID frequencies for better use with mobile phones in our products.

In the present disclosure, it is found that when using mobile phones or readers attached to metal surfaces, there are eddy currents which are present on the surface of the metal which interfere with the ability of the reader (mobile phone) to power and or transmit information. The use of the hybrid design in the designs and processes provided in the present disclosure provide a remarkable improvement in using these current to both power the card and increase the BAUD rate transfer of data back and forth for the card and reader. For example, normal frequencies are targeted at 13.56 MHz for normal readers. One of the most preferable frequency using these antennas may be 15.00 MHZ-16.20 MHz. These target frequencies are different for differ use cases or environments.

These examples show that number of turns of wire and how the size and location of the waveform structures change the frequency higher. Even when longer wire and or more turns in the wire are used in the present disclosure, the Capacitive (CAP) value in the chips is the same for all tests. The antenna designs and resulting products surprisingly provide higher frequency capability, i.e., with higher resonating frequency. In convention wisdom, when the number of coil or the length of coils increases, the resulting frequency decreases. Less turns are used to provide high frequency. In the present disclosure, with the waveform structure, the length of metal wires increases. However, an increased frequency is obtained. More wires in the antenna structure can be used with advantages such as absorption of eddy current to generate power.

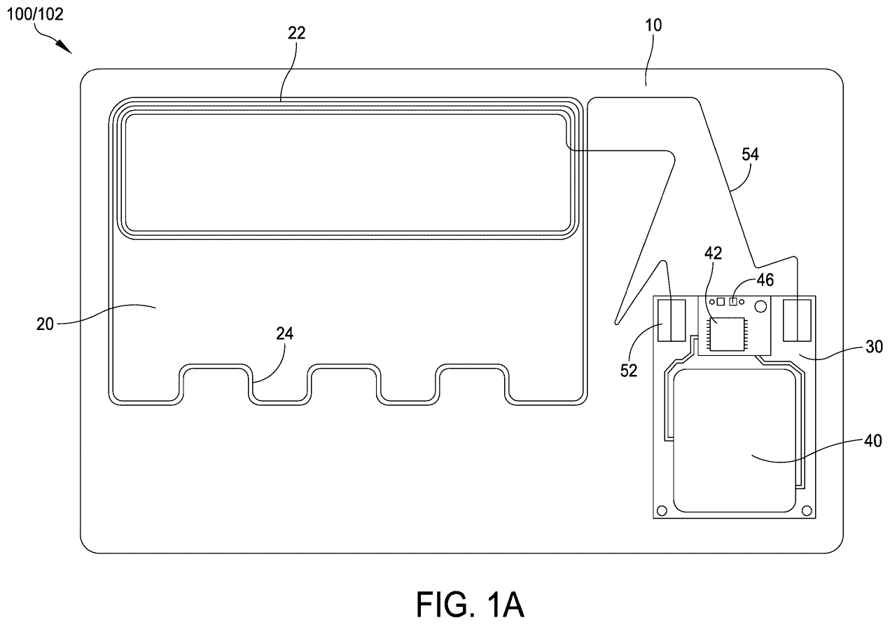

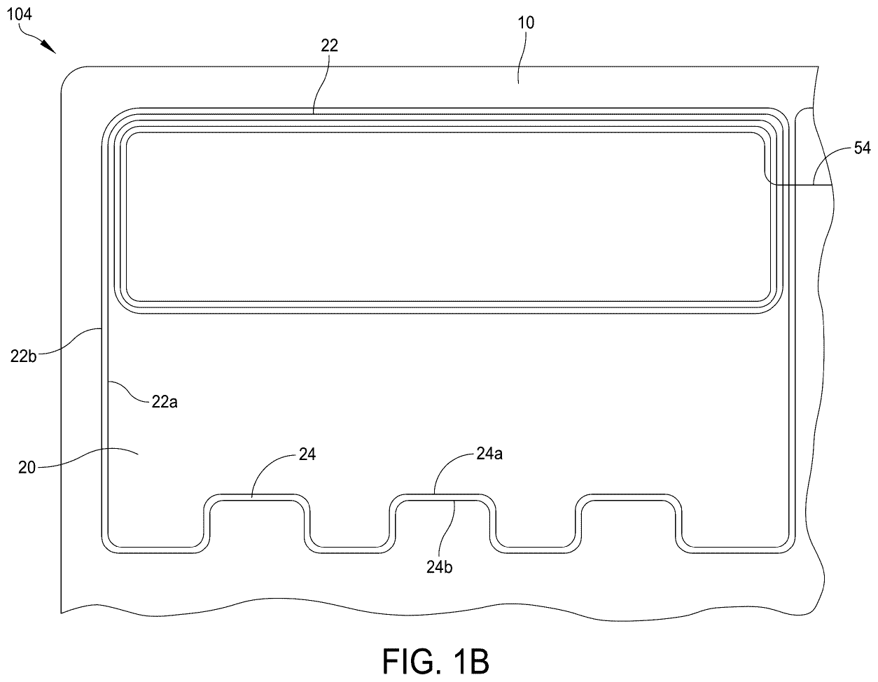

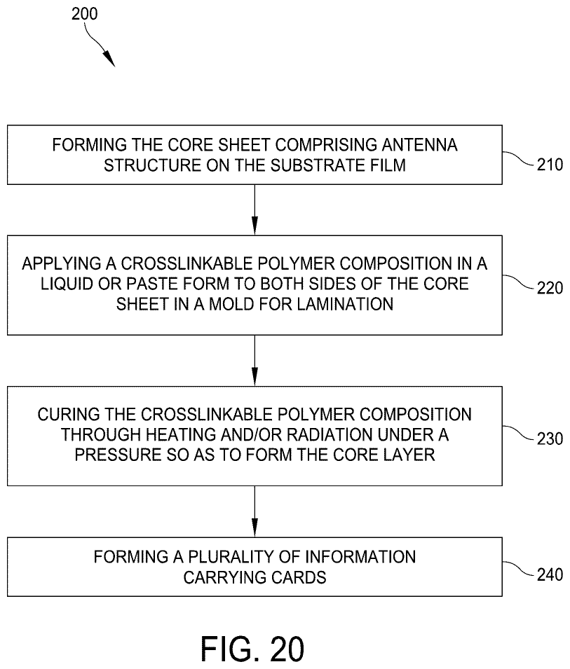

In FIGS. 1A-19, like items are indicated by like reference numerals, and for brevity, descriptions of the structure, provided above with reference to the preceding figures, are not repeated. FIGS. 1A-19 are made from the images of the samples made. The methods described in FIG. 20 are described with reference to the exemplary structure described in FIGS. 1A-19.

For each exemplary antenna structure in each respective core sheet, the frequency described herein refers to a high frequency value referred as a resonating frequency. The frequency number for each antenna is the frequency that design was resonating at through experimental testing on a Vector Network Analyzer (VNA), which is connected with a computer for data analysis. The frequency data is the frequency that the respective antenna structure tunes to or resonates with. A spectrum analyzer such as Rigol DSA 815 spectrum analyzer was also used to test the frequency. The frequency values give the foundation of where that design will best couple with a mobile phone considering the mobile phones case will detune antennas, due to other antennas (coils) inside the phone and the metal cases that have eddy currents running across them due to EMI created by wireless systems.

In each of the exemplary antenna structures described herein, the loops and the waveform structures are all made of one conductive line. The loops and the connection wires 54 are connected with each other or may be also made of the same wire. The end of the loop across the loops as illustrated in the figures is insulative from the loops. The whole antenna structure are connected in series in a big loop. In some embodiments, the conductive line are a thin wire made of copper or copper alloy.

In FIGS. 1A-11, one section of a core sheet 100 or a core layer 150 is illustrated. Each core sheet 100 or core layer 150 may include a plurality of sections as shown, and are configured for fabrication of a plurality of information carrying cards simultaneously. Each section of a core sheet 100 comprises an antenna structure 20 and other components such as at least one chip 40.

FIG. 1A illustrates an exemplary core sheet 102 comprising a first exemplary antenna structure 20 in accordance with some embodiments. FIG. 1B is a magnified view of the exemplary antenna of FIG. 1A.

Referring to FIGS. 1A-1B, one section of an exemplary core sheet 100 is illustrated. Each section of the core sheet 102 comprises an antenna structure 20 and at least one chip 40 disposed on a substrate film 10. The core sheet 102 may also include one or chips 42 in each section. The antenna structure 20 and the chips 40 and 42 are electrically connected with each other through conductive pads 52 and wires 54. The antenna structure 20 and the chips 40 and 42 may also be partially embedded in the substrate film 10. The substrate film 10 is a thermoplastic layer made of a thermoplastic polymer in some embodiments. The chips 40 and 42 may also be disposed on a base layer 30. The base layer 30 is a polymer film in some embodiments. The base layer 30 is optional, and the chips may be disposed directly on the substrate film 10. Each section of the core sheet 100 (such as 102 in FIG. 1A) may include at least one light emitting diode 46.

The antenna structure 20 includes a wire made of a conductive material such as copper or copper alloy. As illustrated in FIGS. 1A-1B, the antenna structure 20 may include a first antenna portion 22 including loops, for example, five loops as illustrated in FIGS. 1A-1B.

Referring to FIG. 1B, the exemplary antenna structure 20 includes a first antenna portion including loops 22, and a second antenna portion including a waveform structure 24. The waveform structure 24 is in some of the loops. The antenna structure 20 illustrated in FIGS. 1A-1B includes five loops in total. The waveform structures 24a and 24b are in two loops labeled as 22a and 22b, respectively. Each of the two loops 22a and 22b has three waveforms, which are in rectangular (or block) shape.

All the loops and waveform structures are all connected and are made of one continuous wire line. The first portion having loops 22 is configured to communicate with a first RF frequency. The waveform structures 24 are configured to communicate with a second RF frequency and utilize eddy current from an external device to power the information carrying card. No battery is needed for the information carrying card. The second RF frequency is higher than the first RF frequency.

The resonating frequency of the first antenna structure is 16.1 MHZ.

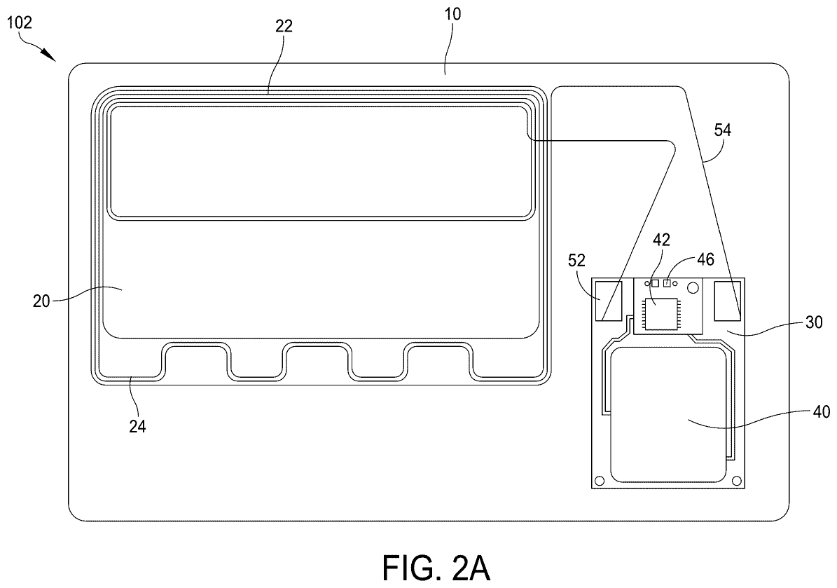

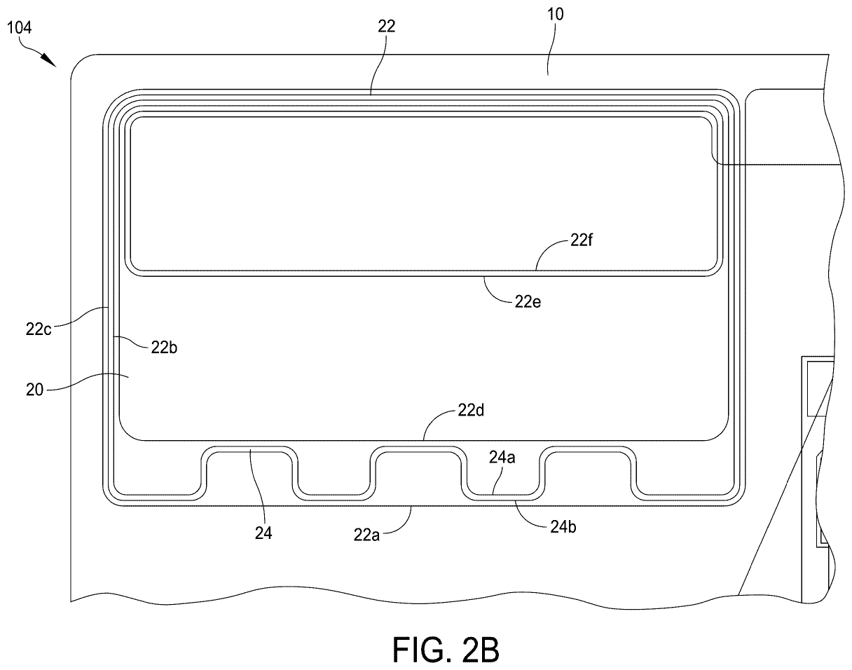

FIG. 2A illustrates a section of core sheet 104 comprising a second exemplary antenna structure in accordance with some embodiments. FIG. 2B is a magnified view of the exemplary antenna of FIG. 2A.

Referring to FIG. 2B, the second exemplary antenna structure 20 includes a first antenna portion including loops 22, and a second antenna portion 24 including a waveform structure 24. The waveform structure 24 is in some of the loops. The antenna structure 20 illustrated in FIGS. 2A-2B includes six loops in total, including loops 22a-22f. The waveform structures 24a and 24b are in two loops labeled as 22b and 22c, respectively. Each of the two loops 22b and 22c has three waveforms, which are in block shape.

In addition to the features described in FIGS. 1A-1B, in the second exemplary antenna structure 20 as shown in FIGS. 2A-2B, two loops 22a and 22b include straight line portions disposed above and below and adjacent to the waveform structures 24a and 24b.

The frequency, which the second exemplary antenna structure 20 tunes to or resonates with, is 13.4 MHz.

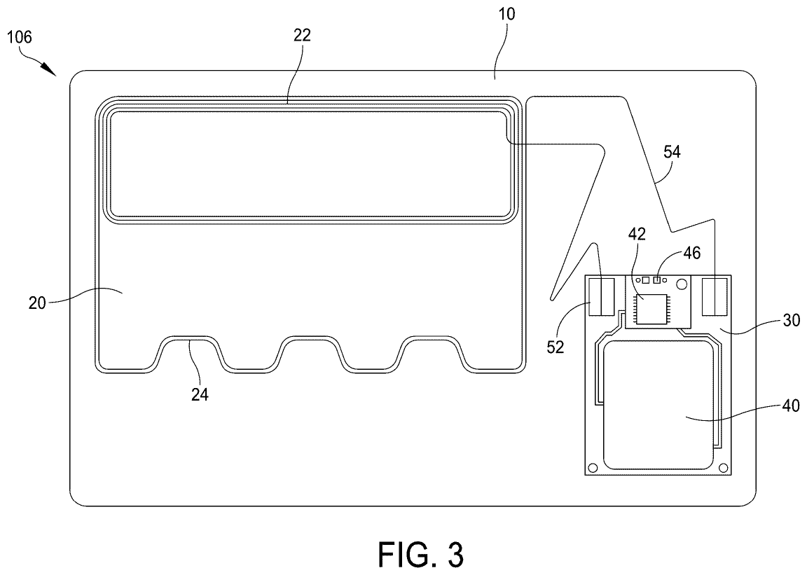

FIG. 3 illustrates another example of an exemplary core sheet 106 comprising a third exemplary antenna structure 20 in accordance with some embodiments.

In the third exemplary antenna structure 20, the number of the loops in total is 5. Two loops include waveform structures 24, and each loop includes three waveform structures. The shape of the waveform structures 24 deviates from the block shape and is more sinuous because the corner of the block shape becomes more smooth. The resonating frequency obtained from the VNA testing is 16.25 MHz.

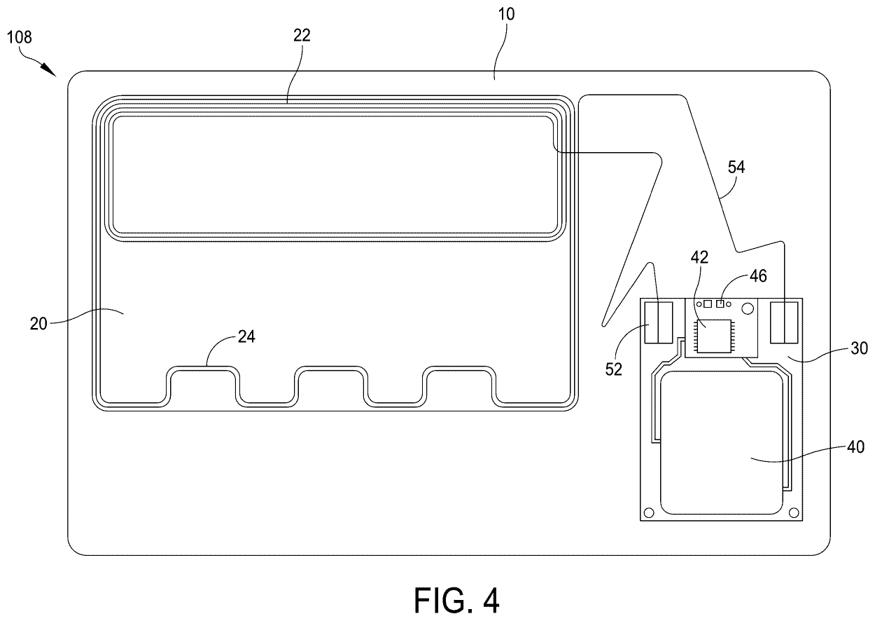

FIG. 4 illustrates another example of an exemplary core sheet 108 comprising a fourth exemplary antenna structure 20 in accordance with some embodiments.

In the fourth exemplary antenna structure 20, the number of the loops in total is 6. Two loops include waveform structures 24, and each loop includes three waveforms. One loop 22 is disposed below the waveform structures 24, and encloses the waveform structures 24 inside this loop.

The resonating frequency obtained from the VNA testing is 13.68 MHz.

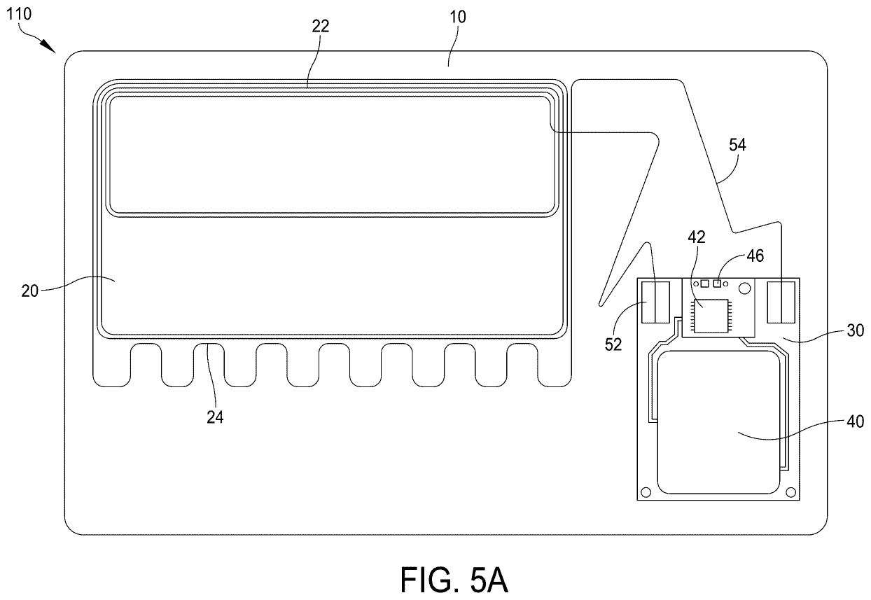

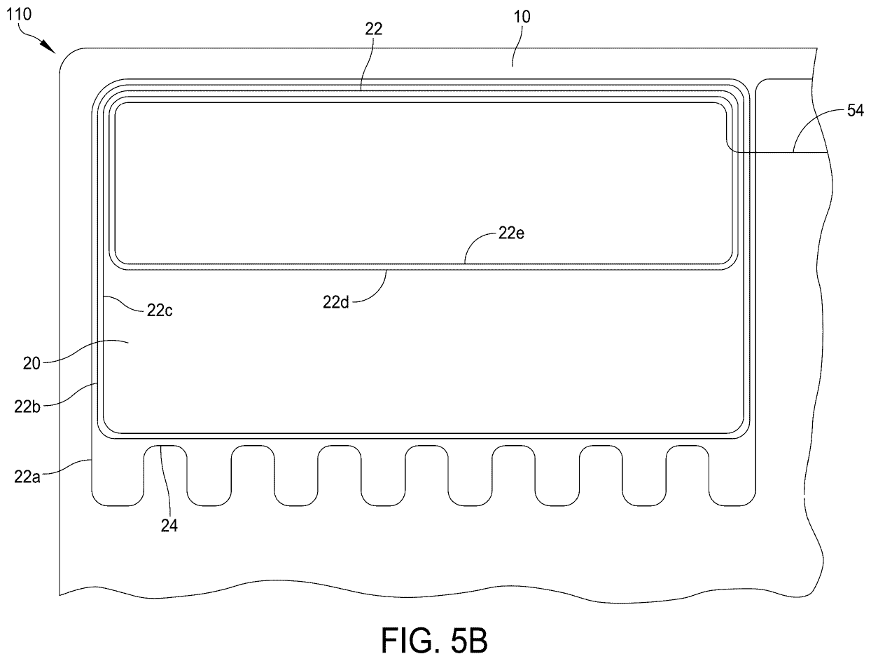

FIG. 5A illustrates another example of an exemplary core sheet comprising a fifth exemplary antenna structure in accordance with some embodiments. FIG. 5B is a magnified view of the exemplary antenna of FIG. 5A.

In the fifth exemplary antenna structure 20, the number of the loops 22 in total is 7. One of the loops 22a includes seven waveform structures 24. Two loops 22b and 22c are disposed above and adjacent to the waveform structures 24. The waveform structures 24 in the loop 22a are disposed outside other loops. The resonating frequency obtained from the VNA testing is 16.08 MHz.

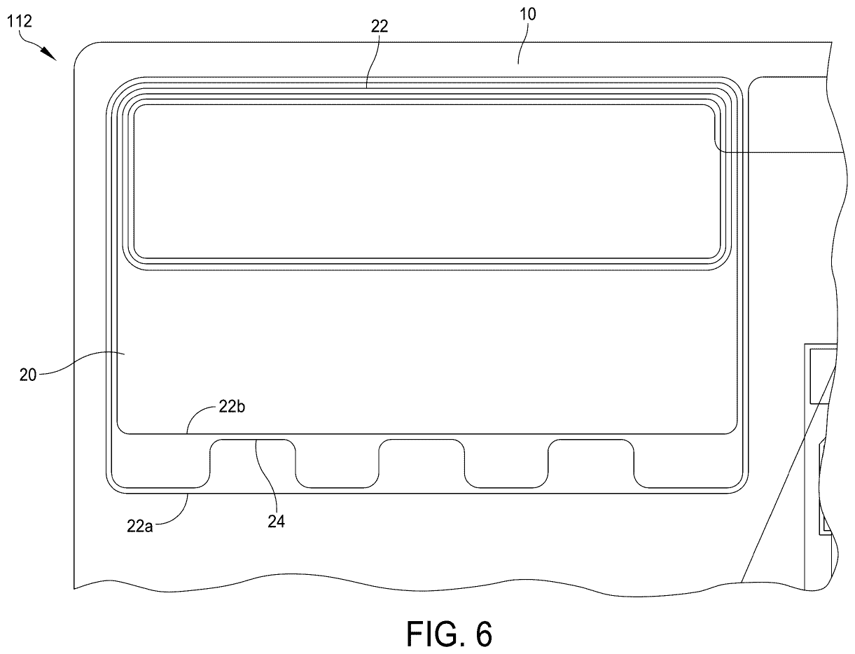

FIG. 6 illustrates an exemplary core sheet 112 having a sixth exemplary antenna structure 20 in accordance with some embodiments.

In the sixth exemplary antenna structure 20, the number of the loops 22 in total is 6. One of the loops 22 includes three waveform structures 24. Two loops 22a and 22b are disposed above and below, and adjacent to the waveform structures 24. The waveform structures 24 are disposed between two loops 22a and 22b. The resonating frequency obtained from the VNA testing is 13.92 MHz.

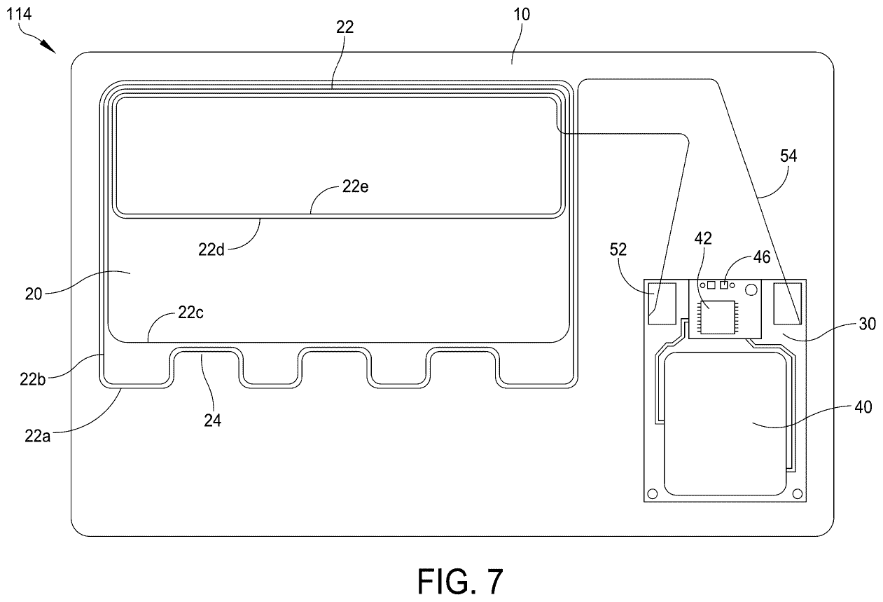

FIG. 7 illustrates another example of an exemplary core sheet 114 comprising a seventh exemplary antenna structure 20 in accordance with some embodiments.

In the seventh exemplary antenna structure 20, the number of the loops 22 in total is 5. The five loops are labeled 22a, 22b, 22c, 22d, and 22c. Two of the loops 22a and 22b include three waveform structures 24. Loop 22c is disposed above and adjacent to the waveform structures 24. The resonating frequency obtained from the VNA testing is 15.87 MHz.

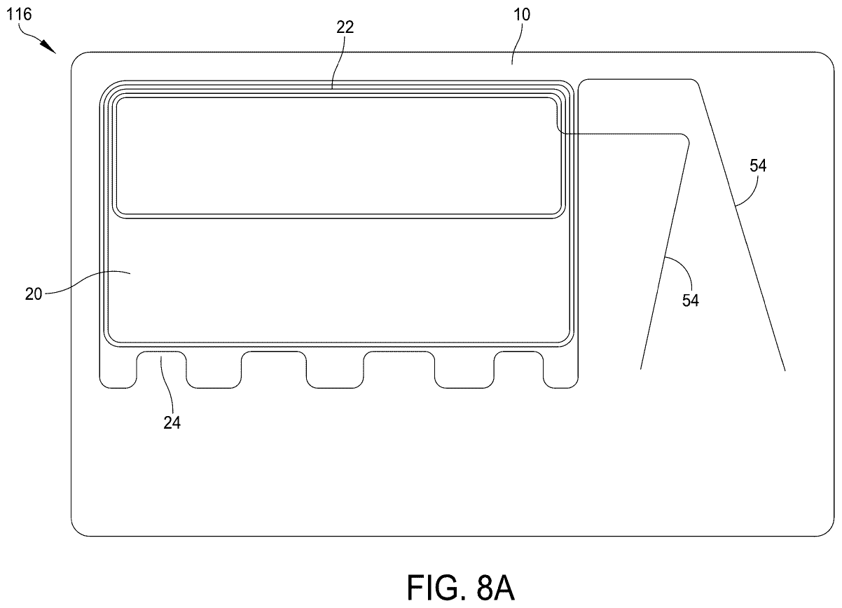

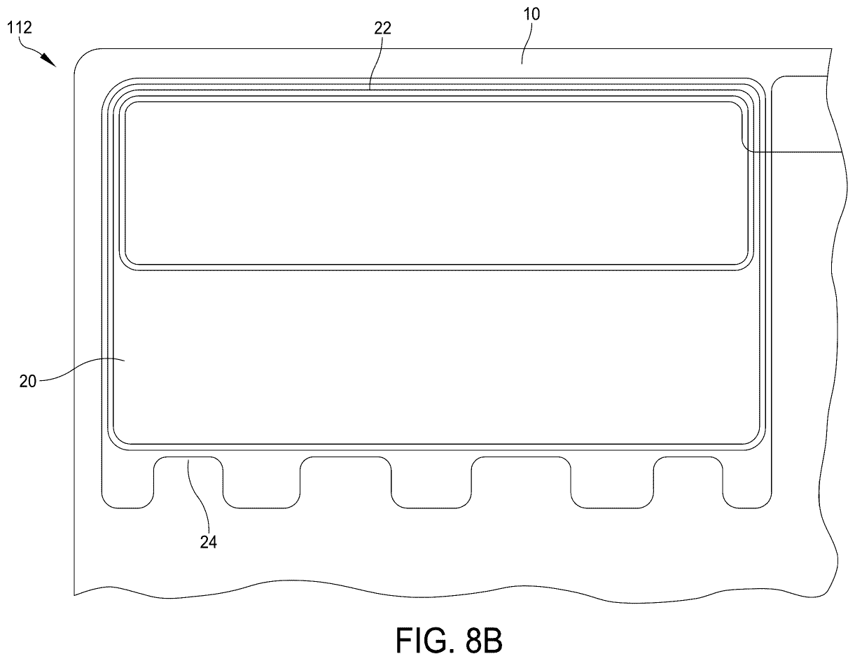

FIG. 8A illustrates an exemplary core sheet 116 comprising an eighth exemplary antenna structure 20 in accordance with some embodiments. FIG. 8B is a magnified view of the exemplary antenna of FIG. 8A.

In the eighth exemplary antenna structure 20, the number of the loops 22 in total is 5. One of the loops 22 includes four waveform structures 24. Two loops are disposed above and adjacent to the waveform structures 24. The waveform structures 24 are disposed outside the loops. The resonating frequency obtained from the VNA testing is 21.5 MHz.

The results of the eight exemplary antenna structures 20 are summarized in Table 1.

TABLE 1

| | | | Loops | | |
|---|---|---|---|---|---|
| | | | adjacent to | | Resonating |
| | Total | | waveforms | Waveform | Frequency |
| FIG. | Loops | Waveforms | (Top/bottom) | Shape | (MHz) |
| 1A | 5 | 2 × 3 | 0/0 | block | 16.1 |
| 2A | 6 | 2 × 3 | 1/1 | block | 13.4 |
| 3 | 5 | 2 × 3 | 0/0 | sinuous | 16.25 |
| 4 | 6 | 2 × 3 | 0/1 | block | 13.68 |
| 5A | 5 | 1 × 7 | 2/0 | block | 16.08 |
| | | | | (toward | |
| | | | | sinuous | |
| 6 | 6 | 1 × 3 | 1/1 | block | 13.92 |
| 7 | 5 | 2 × 3 | 1/0 | block | 15.87 |
| 8A | 5 | 1 × 4 | 2/0 | block | 21.5 |

These examples show the antenna design in use for products. For example, the second, the fourth, and the sixth antenna structures have a resonating frequency close to equal to or close to 13.56 MHz as defined by the ISO/IEC 14443 standard, and may be used for RFID and contactless smart card applications. One or two loops disposed adjacent to the waveform structures, especially enclosing the waveform structures inside the loops, may effectively control the resonating frequency to be in a certain range.

In some embodiments, the exemplary antenna designs comprise waveform structures on two sides of the antennas, i.e., dual sided waveform structures, which can be on the top and bottom of the antenna coils (loops).

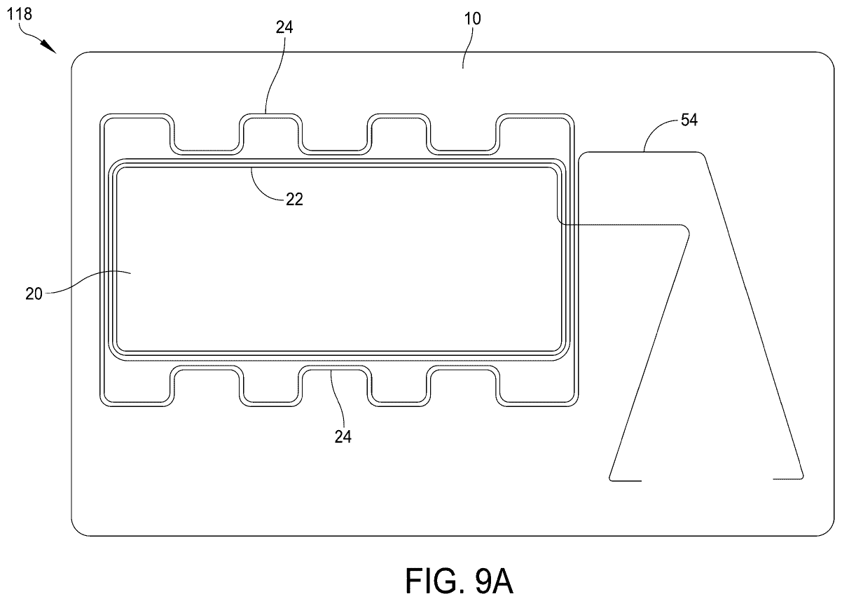

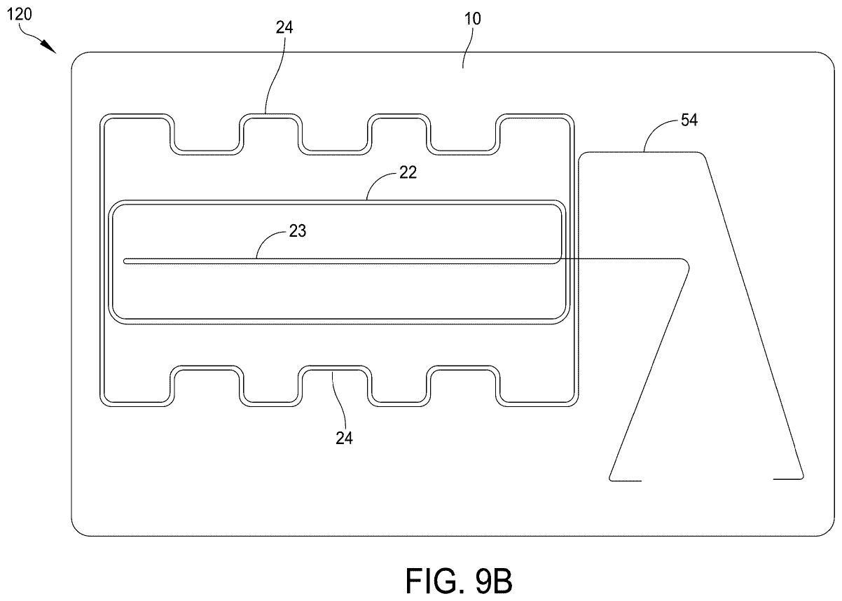

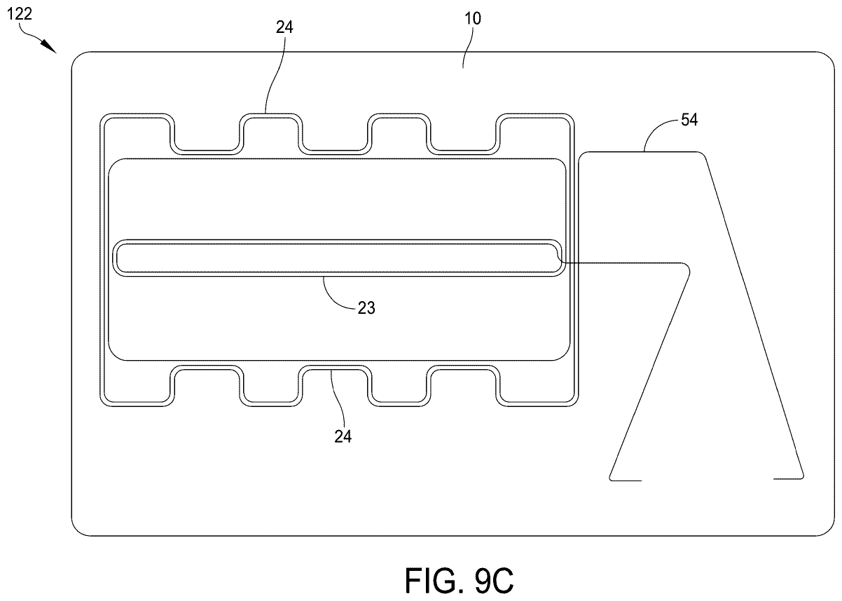

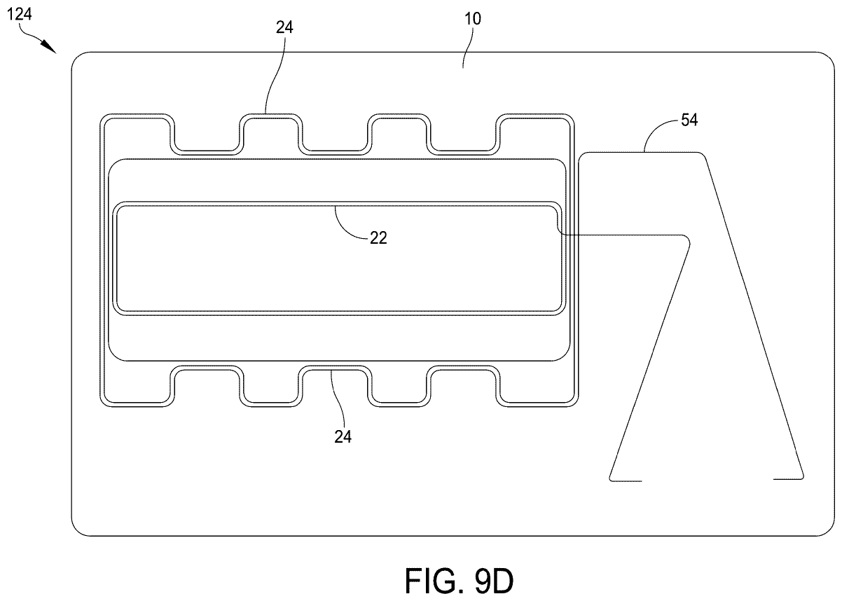

FIGS. 9A-9D illustrates four exemplary core sheets each comprising different exemplary antenna structures 118, 120, 122, 124, each of which has two portions with waveforms, in accordance with some embodiments.

Referring to FIG. 9A, the antenna structure 118 includes five loops in total. Two of the loops include waveform structures, which are disposed adjacent to and outside other loops disposed in the middle. The antenna structure 118 tunes to or resonates at a frequency of 14.15 MHz. FIGS. 9B-9D also illustrate other three examples of exemplary antenna structures, each of which includes at least two sets of waveform structures disposed on two sides of the loops.

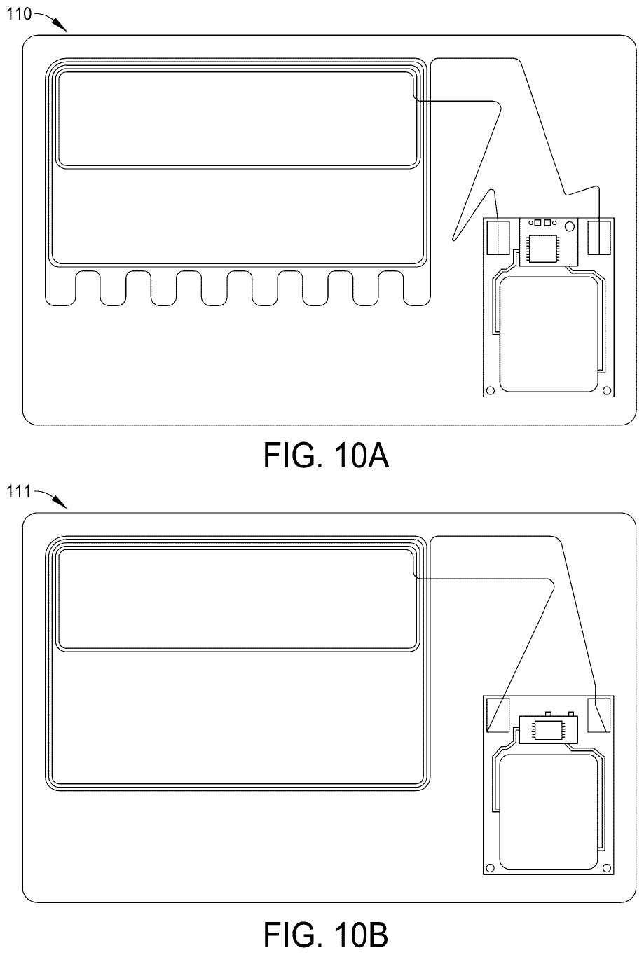

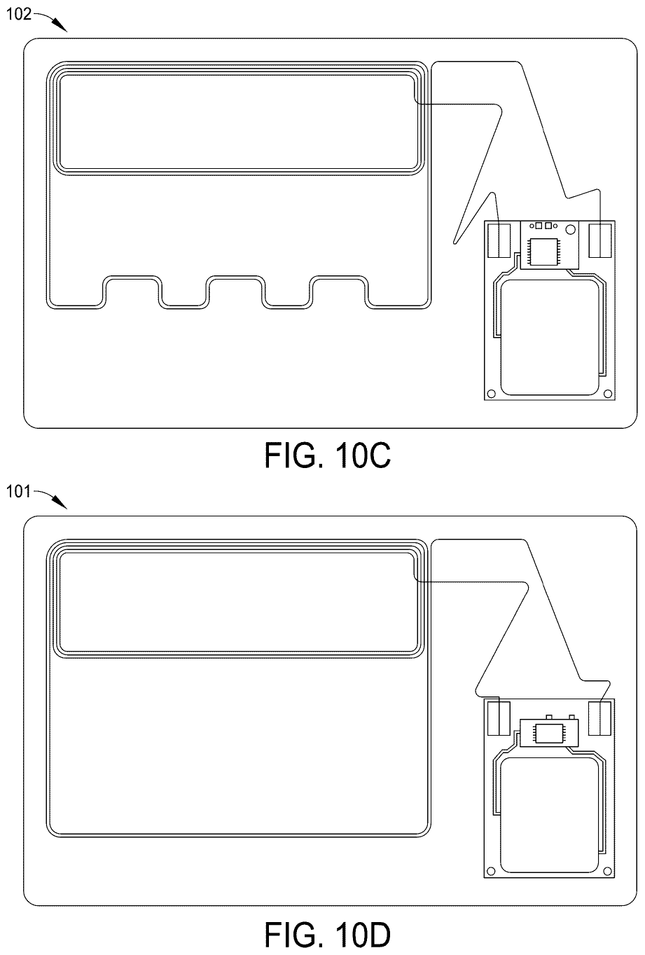

FIGS. 10A-10B illustrate comparison between one exemplary antenna structure and one comparative antenna structure. FIGS. 10C-10D illustrate comparison between another exemplary antenna structure and another comparative antenna structure. The antenna structure in FIG. 10B is compared to that in FIG. 10A, but does not include waveform structures. Similarly, the antenna structure in FIG. 10D is compared to that in FIG. 10C, but does not include waveform structures. The frequency data obtained for the antenna structures in FIGS. 10A, 10B, 10C, and 10D are 16.08 MHz, 15.51 MHz, 16.1 MHZ, and 15.3 respectively.

In another aspect, the present disclosure provides a core layer for an information carrying card, comprising one or a plurality of core sheets as described herein.

In some embodiments, the core layer comprises a crosslinked polymer disposed on both side of the core layer. In some embodiments, the core layer is self-centered in the crosslinkable polymer before curing in a thermal lamination process under a temperature and a pressure. In such a method, a crosslinkable polymer in a liquid or paste form is applied to both sides of the core sheet in a mold for thermal lamination. The mold includes a height adjustment edges to define the thickness. During a curing process at a low temperature and under a pressure, the core sheet self-centers in the mold with the help of the crosslinkable polymer.

In some embodiments, the core layer includes a plurality of section and is configured to be for a plurality of information carrying cards. Each section comprising one antenna structure.

In another aspect, the present disclosure provides an information carrying card comprising the core sheet or the core layer as described herein.

In another aspect, the present disclosure provides a method of making the core sheet as described herein.

In another aspect, the present disclosure provides a method of making the core layer as described herein.

In another aspect, the present disclosure provides a method of making one or a plurality of the information carrying cards as described herein.

The inventor's previous patents and patent applications, for example, U.S. Pat. No. 10,339,434, and U.S. application Ser. No. 17/970,155, are incorporated herein by references. The descriptions on material selections and general procedures for making a plurality of information carrying cards can be applicable to the products and the methods of the present disclosure.

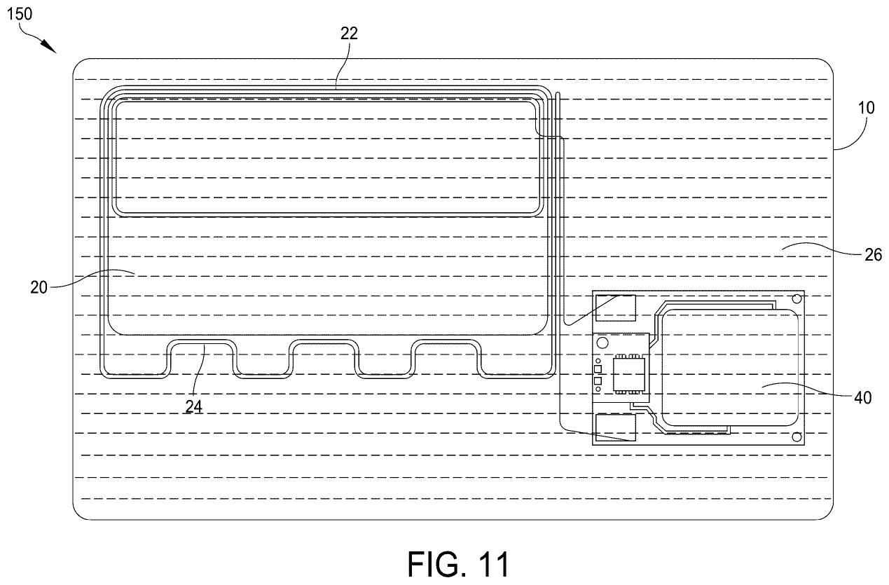

FIG. 11 illustrates an exemplary core layer 150 for an information carrying cards in accordance with some embodiments. Only one section of the core layer is illustrated. The core layer may include a plurality of such sections for a plurality of information carrying cards.

In some embodiments, the core layer 150 comprises a crosslinked polymer 26 disposed on both sides. The crosslinked polymer 26 disposed on both side of a core sheet 100.

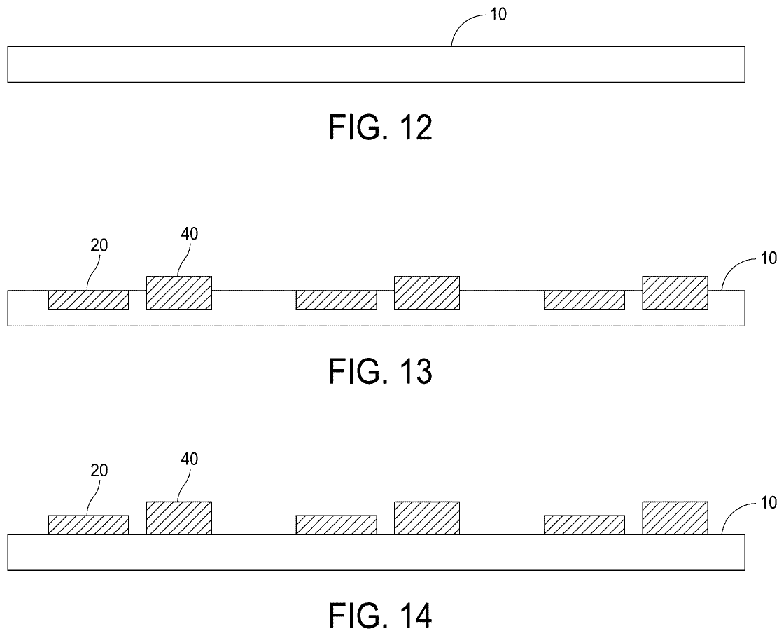

Referring to FIGS. 12-15, the methods of making the core sheet 100 and the core layer 150 comprising the core sheet 100 are illustrated.

Referring to FIG. 13, a substrate film 10 is illustrated. Examples of a suitable substrate film 10 include, but are not limited to, a polymer, a paper, plasticized paper, a composite, and any combination thereof. The substrate film can be any other material that can have or create to have molding properties or adhesive abilities. For example, an adhesive sheet can be also used. In some embodiments, an adhesive or adhesion promoter can be used on the substrate film 10 to achieve high bonding strength.

In some embodiments, the substrate 10 is a film. The substrate is a first thermoplastic layer comprises or is made of a thermoplastic polymer. Examples of a suitable first thermoplastic layer include, but are not limited to, polyvinyl chloride (PVC), a copolymer of vinyl chloride, polyolefin, polycarbonate, polyester, polyamide, acrylonitrile butadiene styrene copolymer (ABS), and the like or a combination thereof. The first thermoplastic layer may be a PVC, a copolymer of vinyl chloride and another monomer such as vinyl ether, vinyl ester or vinyl acetate, or a PVC modified with a vinyl chloride copolymer. Examples of PVC films suitable for use are available from suppliers such as Klockner Pentaplast of America, Inc. of Gordonsville, VA; and Shijiazhuang Eurochem Co. Ltd of China. Examples of such a vinyl chloride copolymer resin are available from Dow Chemical Company under trade name of UCAR®, and from BASF of Ludwigshafen, Germany under trade name of LAROFLEX®. UCAR® is a copolymer of vinyl chloride and vinyl acetate, and includes grades such as YYNS-3, VYHH and VYHD. LAROFLEX® is a copolymer of vinyl chloride and vinyl isobutyl ether, and includes grades such as MP25, MP 35, MP45 and MP60. These polymer resins may be supplied as fine powder, which is added to modify PVC resins for films. In some embodiments, such a thermoplastic layer can be transparent or translucent.

Referring to FIG. 13-14, the antenna structure 20 is disposed on or embedded within the substrate film 10. As illustrated in FIG. 13, the antenna structure 20 is at least partially embedded within the substrate film 10 in some embodiments. As illustrated in FIG. 14, the antenna structure 20 is disposed on the substrate film 10. Similarly, other electronic components such as chip 40 may be disposed on or embedded within the substrate film 10 as illustrated in FIGS. 13-14.

In some embodiments, the antenna structure 20 is made of a wire or a thread, and the conductive material is made of a metal or metal alloy. For example, the conductive material is made of copper or copper alloy. The conductive material such as copper can be applied or formed using any suitable techniques, for example, vapor deposition, printing, or cladding. Wire or copper clad is etched into the substrate film.

For example, the conductive material such as copper can be vapor deposited or printed on a substrate 10 such as a thermoplastic layer or film. A portion of a core sheet 100, which includes a plurality of antenna structures 20 and interconnects 62 including conductive pads 64. The antenna structures 20 and the interconnects 64 comprise a conductive material such as metal or metal alloy printed on the substrate in accordance with some embodiments. For example, the conductive material is copper or copper alloy in some embodiments. The number of sets of antenna structures 20 in one core sheet or core layer may be the same as the number of information carrying cards to be made simultaneously.

The present disclosure also provides a core sheet 100 comprising an antenna structure 20 as described herein.

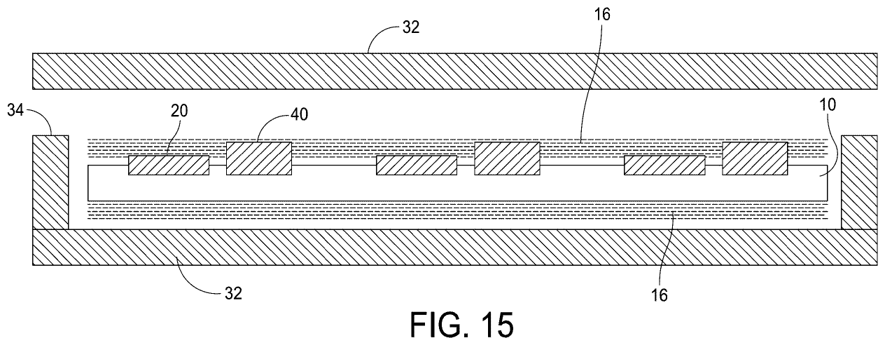

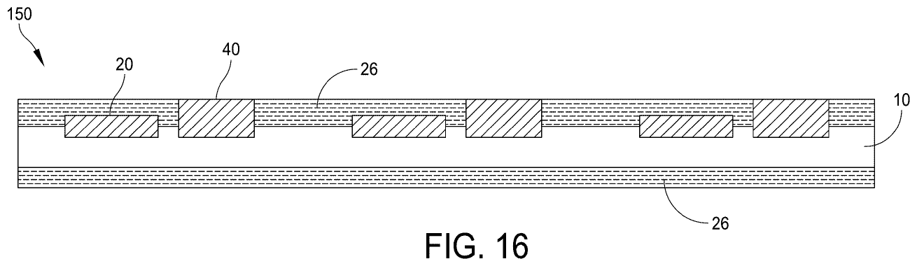

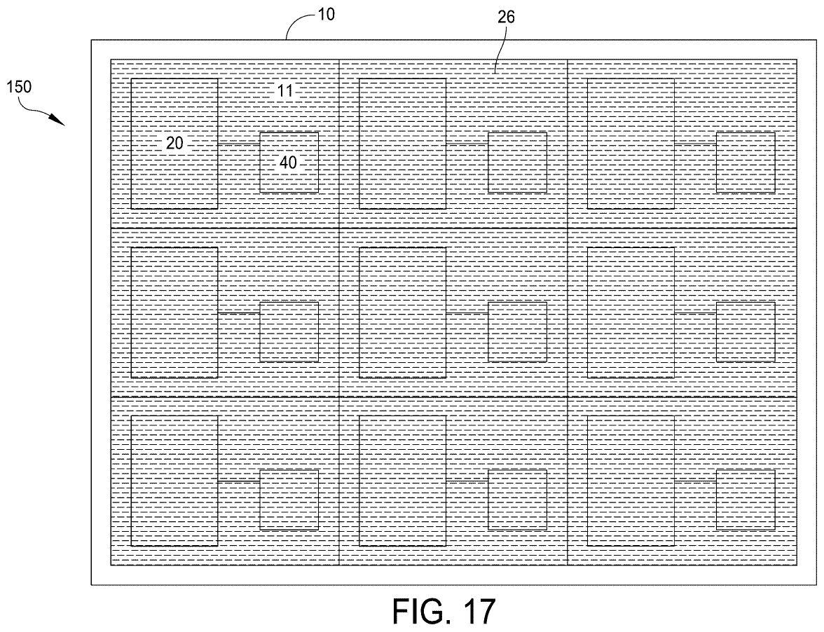

Referring to FIG. 15, a method of making the core layer 150 is illustrated. The resulting core layer 150 is illustrated in FIGS. 16 and 17.

In such a method, a crosslinkable polymer in a liquid or paste 16 form is applied to both sides of the core sheet 50 in a press for thermal lamination. The “press” used herein can be also called “a mold” or “a plating system.” The press 32 includes a height adjustment edges 34 to define the thickness. In some embodiments, the core sheet 50 includes a substrate layer 10 such as a first thermoplastic layer made of a thermoplastic polymer, and an antenna structure 20 and a chip 40 disposed on or embedded within the first thermoplastic layer.

The substrate film 10 is centered in the crosslinkable composition 16 in a direction normal to a plane of the core layer 150. During a thermal lamination process for making the core layer, the core sheet self-centered in a crosslinkable polymer composition 16 before the crosslinkable polymer composition 16 is cured to become the crosslinked polymer composition 26.

In some embodiments, the core sheet 100 is self-centered in a crosslinkable polymer during curing in a thermal lamination process under a temperature and a pressure relative to the thickness direction.

A cross-linkable polymer composition used often comprises a curable base polymer resin in a liquid or paste form or may be in a form of a hot melt adhesive. The cross-linkable polymer composition also comprises at least one initiator and/or curative for thermal curing, thermal curing, or a combination thereof. The cross-linkable polymer composition may optionally comprises other additives or fillers such as a particulate thermoplastic filler. The base polymer resin may be selected from the group consisting of urethane acrylate, ester acrylate, silicone acrylate, epoxy acrylate, acrylate, epoxy, and urethane. The acrylate may be a methacrylate. The particulate thermoplastic filler may be polyolefin, polyvinyl chloride (PVC), a copolymer of vinyl chloride and at least another monomer, or a polyester such as polyethylene terephthalate (PET). The particulate thermoplastic filler may be a compound or a blend comprising a thermoplastic resin, for example, a compound or a blend comprising PVC or a vinyl chloride copolymer. The at least another monomer in the vinyl chloride co-polymer may be vinyl ester, vinyl acetate or vinyl ether.

The base polymer resin may be an oligomer or pre-polymer having functional groups. The base polymer can be cross-linkable under a regular curing conditions including but not limited to heating, radiation such as ultraviolet (UV) light, moisture and other suitable conditions. The base polymer may be in liquid or paste form. Its viscosity may be in the range of 100-100,000 cps, for example, from 1,000 cps to 20,000 cps, from 2,000 cps to 20,000 cps, from 3,000 cps to 12,000 cps, or from 3,000 cps to 8,000 cps. In some embodiments, the base polymer resin is urethane acrylate or epoxy.

In some embodiments, an epoxy or urethane acrylate is preferred. Such an epoxy or urethane acrylate is thermally curable or radiation such as UV or visible light curable, and are unfilled. After crosslinked, the cured polymer is optically transparent while electrically insulative.

The initiator and/or curative may be based on general principles of polymer chemistry. In some embodiments, the composition comprises thermal curing mechanism only, and can be cured at relatively low temperature such as above 40° C. and less than 150° C. or 120° C. In some embodiments, the composition comprises a dual curing mechanism. For example, the cross-linkable composition comprises a first curative for thermal curing and a second curative for radiation curing. During the curing or cross-linking reaction, such a cross-linkable composition transforms into a solid cross-linked polymer composition. Such a cross-linked polymer composition is also known in the art as a “thermosetting” polymer or “thermoset” to distinguish it from a thermoplastic polymer, which does not have a crosslinked structure. In some embodiments, the cross-linkable polymer composition comprises a range of from about 60 wt. % to about 99.5 wt. %, and preferably in the range of about 50 wt. % to about 95 wt. %, of the base polymer. The cross-linkable polymer composition optionally comprises a range of about 0.5 wt. % to about 40 wt. % such as about 5 wt. % to about 15 wt. %, of the additives such as a particulate thermoplastic filler. It is preferably to have a transparent crosslinkable polymer composition, which retains transparency after crosslinked.

Such a cross-linkable polymer composition 16 is transformed into a cross-linked polymer composition 26 after a curing reaction under suitable conditions, for example, under a thermal or radiation condition or a thermal condition in combination with a radiation condition. The radiation can be ultra-violet (UV), visible light, or infra-red (IR). In some embodiments, under such a thermal condition, the curing reaction occurs at a relatively low temperature, for example, less than 150° C., less than 120° C., or less than 100° C. Exemplary suitable temperature may be in a range of from 40° C. to 150° C., from 40° C. to 120° C., from 40° C. to 100° C., from 50° C. to 150° C., from 50° C. to 120° C., from 50° C. to 100° C., from 60° C. to 150° C., from 60° C. to 120° C., from 60° C. to 100° C., from 70° C. to 150° C., from 70° C. to 120° C., or from 70° C. to 100° C.

The cross-linkable polymer composition can be dispensed using a suitable dispensing apparatus or equipment for adhesives, encapsulants, sealants and potting compounds, for example, a robot with dispensing function. The amount to the cross-linkable polymer composition 16 to be dispensed can be calculated and controlled. For example, the thickness of the cross-linkable polymer composition 16 may be about 0.025 mm or less, for example, in a range of from 0.005 mm to 0.025 mm.

During the stage of manufacturing a core or core layer for one or more information carrying card, a layered structure is formed. The layered structure can be degassed and then pressed within a press. The edges of the press may include spacers or the edges of the press may function with spacers to control the thickness of the layered structure after cured. The layered structure may be heated when it is pressed.

The crosslinkable polymer composition is cured under a pressure and a temperature. For example, it is cured at a raised temperature of above 40° C. and less than 150° C. such as about 90-100° C.) under a pressure of less than 2 MPa. The crosslinkable polymer composition becomes a crosslinked polymer composition, which is in a solid form, but may have flexibility. In some embodiments, the polymer composition is transparent before and after crosslinked.

When the layered structure is degassed, pressed, and/or cured, in this unique design, the inlay layer can move freely, thus self-center, inside the crosslinkable polymer composition. The core sheet can move and center in a direction along vertical direction of the mold. In another word, the inlay layer can move and center vertically and normal to a plane of the thermoplastic layer.

A suitable temperature for curing would be one that is sufficiently high to cure the cross-linkable polymer composition. Hot lamination of the thermoplastic layers may also occur for any areas without having crosslinkable polymer composition. After the heat treatment, the cross-linkable polymer composition forms a solid. Such a cross-linked polymer composition has good adhesion with each thermoplastic layer and inlay layer 8 including electronic component and supporting film. In some embodiments, such a cross-linked composition is more flexible than any of the thermoplastic layers used. In some embodiments, curing methods such as visible light, UV or other radiation curing can be also used, separately or in combination with thermal curing. It may also comprise a step of curing via the introduction of moisture or the promotion of other chemical reactions.

In some embodiments, the crosslinked polymer composition may have a hardness (Shore D) in a range from 10 to 85, for example, from 20 to 80, a tensile strength in a range of from 20 MPa to 100 MPa, for example, from 30 MPa to 60 MPa, an elongation in a range of from 1% to 20%, for example, from 2% to 10%, and a Young's modulus in a range of from 0.5 GPa to 8 GPa, for example, from 1 GPa to 5 GPa, following ASTM testing standards.

FIGS. 16-17 illustrate an exemplary core layer 150 comprising the exemplary core sheet as described herein. FIG. 16 illustrates a plurality of exemplary information carrying cards 160. FIG. 17 illustrates one exemplary information carrying card 160.

In accordance with some embodiments, a core layer 150 is configured to be used for making a plurality of information carrying cards 160. Such a core layer 150 comprises a substrate 10, and a plurality of component sections 10, which together are referred as a core sheet 100. Each component section 11 comprises an antenna structure 20 disposed on or embedded within the substrate film 10. The antenna structure 20 comprises a wire made of a conductive material. Each section 11 further comprises at least one chip 40 disposed on or embedded within the substrate film 10, and electrically connected with the antenna structure 20. One exemplary section 11 is also illustrated in FIG. 11.

In some embodiments, the core layer 150 further comprises a light emitting diode (LED) 46 electrically connected with the antenna structure and the chips.

In another aspect, the present disclosure provides a method of making the core sheet and a core layer as described herein. The antenna structure are formed as described herein.

FIG. 20 is a flow chart illustrating an exemplary method 200 of making a core layer for a plurality of information carrying card in accordance with some embodiments

At step 210, the core sheet 100 comprising antenna structure 20 is formed on the substrate film 10. The antenna structure 20 in each section of the core sheet is provided or formed on the substrate film 10. The conductive material in the antenna structure 20 can be applied on the substrate film 10 through vapor deposition, printing, or cladding technique, or any combination thereof.

At step 220, a crosslinkable polymer composition 16 in a liquid or paste form is applied to both sides of the core sheet 100 in a press for lamination.

At step 230, the crosslinkable polymer composition 16 is cured through heating and/or radiation under a pressure so as to form the core layer. The crosslinkable polymer composition 16 is converted into the crosslinked polymer composition 26. During a curing process at a low temperature and under a pressure, the core sheet self-centers in the press with the help of the crosslinkable polymer. In some embodiments, the core layer 150 comprises a crosslinked polymer disposed on both side of the core layer. In some embodiments, the core sheet is self-centered in the crosslinked polymer before curing in a thermal lamination process under a temperature and a pressure.

In another aspect, the present disclosure provides a core sheet or a core layer for a plurality of information carrying cards. The core layer comprising a core sheet having a plurality of core sections as described herein. The present disclosure also provide the resulting core sheet, the resulting core layer, and the resulting information carrying card.

In some embodiments, the core layer comprises a crosslinked polymer disposed on both side of the core layer. In some embodiments, the core sheet is self-centered in the crosslinked polymer before curing in a thermal lamination process under a temperature and a pressure. In such a method, a crosslinkable polymer in a liquid or paste form is applied to both sides of the core sheet in a press for thermal lamination. The press includes a height adjustment edges to define the thickness. During a curing process at a low temperature and under a pressure, the core sheet self-centers in the press with the help of the crosslinkable polymer.

Referring to FIG. 20, at step 240, a plurality of information carrying card is formed. A transparent thermoplastic layer and a printable thermoplastic layer can be applied to one or two sides of the core layer 150.

In some embodiments, the following steps are used in an exemplary process:

1. A first thin (e.g., 0.012 mm to 0.0508 mm) PVC or other suitable material as the substrate film is placed flat. A paper or paper-based products can be also used depending on choice of construction.

2. A first portion of the crosslinkable polymer composition is dispersed onto the substrate film. The composition may be an epoxy group containing polymer. A heat and/or UV curable composition can be used. A sheet-based adhesive can be also used depending on the solution being utilized. Options exist due to the prevalence and desire to move to more eco-friendly products. An adhesive sheet at this layer is used depending on substrate used.

3. One of the core sheet is applied onto the substrate layer with a crosslinkable composition dispensed, while centering it to either registration holes or sheet size.

4. A second portion (or layer) of the crosslinkable polymer composition is dispersed onto the top of the core sheet. A window-cut adhesive sheet can be also used depending on substrate choice.

5. A second thin (e.g., 0.012 mm to 0.0508 mm) PVC or other suitable material is applied on top of the second portion of the crosslinkable polymer composition.

6. This layer of PVC may be sealed if required by the material used. If a liquid crosslinkable composition is used, the combined layers is vacuumed to remove all and any air that may have entered the array/stack up.

7. The stack-up layered structure is placed into plating system, which may include shimmed plate or normal plate set-up.

8. The crosslinkable polymer composition is cured either by using temps of 40-150° C. or radiation such as UV. UV can be also used depending on desired product to be made. When UV is used, no heating may be required. No heat is needed for a pressure activated cold adhesive.

The PVC films can be replaced with any other thermoplastic layers such as PET films or other suitable substrate films.

In another aspect, the present disclosure provides an information carrying card comprising the core sheet or the core layer as described herein. In another aspect, the present disclosure provides a method of making the core sheet as described herein. In another aspect, the present disclosure provides a method of making the core layer as described herein.

In another aspect, the present disclosure provides a method of making one or a plurality of the information carrying cards as described herein.

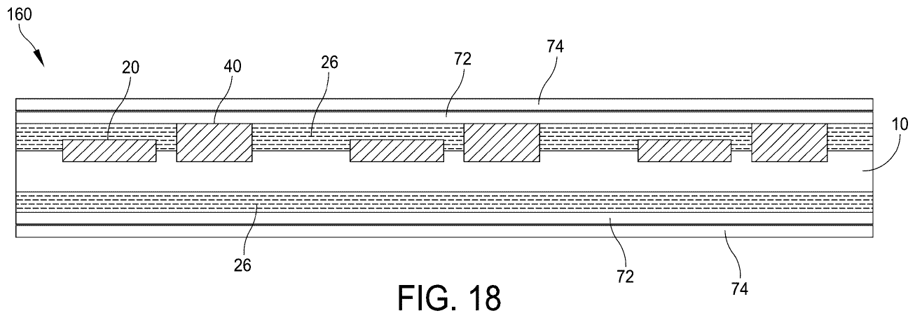

FIG. 18 is a sectional view illustrating a plurality of information carrying cards being made in accordance with some embodiments.

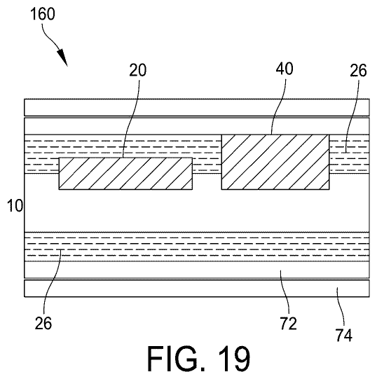

FIG. 19 is a section view illustrating an information carrying card after a step of cutting from the plurality of information carrying cards shown in FIG. 18. The dimensions are not based on the actual scale, and the drawings are for the purpose of illustration only.

A plurality of information carrying cards are made through hot lamination.

A transparent thermoplastic film may be laminated on each side of the core layer through hot lamination. A transparent thermoplastic film may be optional.

A transparent film 74 can be used as the outer layer of an information carrying card. Examples of transparent film include but are not limited to PVC, modified PVC and PET.

A printable thermoplastic film 72 is laminated on one or both sides of the core layer through hot lamination.

A printable thermoplastic film layer may be disposed onto on the core layer directly, or on a transparent film, which may be laminated onto the core layer first. The printable thermoplastic film is an imaging receiving layer. Words or images can be printed onto the printable thermoplastic film before or during a process of making an information card. In some embodiments, this film is not transparent, and contains some pigments such as white pigments.

The order of the transparent film and the printable thermoplastic film may be interchangeable.

A suitable temperature for hot lamination is sufficiently high so that all the films are laminated with good adhesion. In some embodiments, the temperature is in the range of 65-232° C. In some embodiments, the temperature is less than 150° C.

The uses of the final products may include, but are not limited to, display technologies, toys, auto motive uses, packaging of components for other industries or other devices. The products may include, but are not limited to cards, key chain tags, and pet products (e.g., for tracking). Metal card and tag or other form factor creations can be made. Instead of metal, other suitable materials such as ceramics, wood may be also used.

The overall process with this technology to make the core sheet and core layer saves manufacturing cost significantly while also improving the performance. In some embodiments, the manufacturing cost decrease by at least 90%.

The core layer may also include other additional layers or components based on different product design. For example, additional thermoplastic layers may be used. The core layer may also comprise a piece of metal, ceramic or plastic materials in the core layer of some information carrying cards. The piece of metal such as steel may be separate from the inlay layer 8 and is for decoration or weight only. The core layer having a piece of metal can be used to make “metal cards,” which are a type of information carrying card weighing more than an information carrying card without such a piece of metal. In some embodiments, the piece of metal has a size large enough to provide edges for an information carrying card. After the process for making the information carrying card including final cutting steps, the edges of the metal piece are exposed and define the exterior edges of the resulting metal cards.

Although the subject matter has been described in terms of exemplary embodiments, it is not limited thereto. Rather, the appended claims should be construed broadly, to include other variants and embodiments, which may be made by those skilled in the art.

What is claimed is:

1. A core sheet configured to be used for making a plurality of information carrying cards, comprising
a substrate film; and
an antenna structure disposed on or embedded within the substrate film, the antenna structure comprising a wire made of a conductive material and comprising
a first antenna portion including a plurality of loops and configured to communicate with a first RF frequency; and
a second antenna portion including a waveform structure in at least one of the plurality of loops, the waveform structure configured to communicate with a second RF frequency and utilize eddy current from an external device to power the information carrying card, wherein the second RF frequency is higher than the first RF frequency.

2. The core sheet of claim 1, wherein the substrate film comprises a polymer, a paper, plasticized paper, a composite, or any combination thereof.

3. The core sheet of claim 2, wherein the substrate film is a first thermoplastic layer made of a thermoplastic polymer.

4. The core sheet of claim 1, further comprising at least one integrated circuit disposed on or embedded on the substrate film, and electrically connected with the antenna structure.

5. The core sheet of claim 1, the first antenna portion and the second antenna portion are connected and is made of one metal wire.

6. The core sheet of claim 5, wherein the metal wire is made of copper or copper alloy.

7. The core sheet of claim 5, wherein the antenna structure are connected with at least one integrated circuit by laser melting of the conductive material or by a conductive tape.

8. The core sheet of claim 1, wherein the conductive material are printed on the substrate film.

9. The core sheet of claim 1, wherein the antenna structure is configured to generate power so as to operate one of the plurality of information carrying card for communication at a high frequency equal to or close to 13.56 MHz as defined by the ISO/IEC 14443 standard.

10. The core sheet of claim 1, wherein the antenna structure is configured to generate power so as to operate one of the plurality of information carrying card at a high frequency in a range of from 13 MHz to 18 MHz.

11. A core layer for a plurality of information carrying cards, comprising the core sheet of claim 1.

12. The core layer of claim 11, comprising a crosslinked polymer disposed on both side of the core sheet.

13. The core layer of claim 11, wherein the core layer is self-centered in a crosslinked polymer in a direction normal to a plane of the core layer.

14. The core layer of claim 11, wherein the core layer including a plurality of section, each section comprising one antenna structure.

15. A method of making the core layer of claim 11, comprising
forming the core sheet on the substrate film;
applying a crosslinkable polymer composition in a liquid or paste form to both sides of the core sheet in a press for lamination; and
curing the crosslinkable polymer composition through heating and/or radiation under a pressure so as to form the core layer, wherein the crosslinkable polymer composition is converted into the crosslinked polymer composition.

16. The method of claim 15, wherein the antenna structure are connected with at least one integrated circuit by laser melting of the conductive material or by a conductive tape.

17. The method of claim 15, wherein the conductive material in the antenna structure is applied on the substrate film through vapor deposition, printing, or cladding technique, or any combination thereof.

18. An information carrying card comprising the core sheet of claim 1.

19. The information carrying card of claim 18, further comprising a crosslinked polymer composition disposed on both side of the substrate film, wherein the substrate film is centered in the crosslinked composition in a direction normal to a plane of the core sheet.

20. An information carrying card comprising one section of the core layer of claim 11.

21. The information carrying card of claim 20, further comprising a crosslinked polymer composition disposed on both side of the substrate film, wherein the substrate film is centered in the crosslinked composition in a direction normal to a plane of the core layer.

22. The information carrying card of claim 20, wherein the substrate film comprises a polymer, a paper, plasticized paper, a composite, or any combination thereof.

23. The information carrying card of claim 20, wherein the substrate film is a first thermoplastic layer made of a thermoplastic polymer.

24. The information carrying card of claim 20, wherein the antenna structure is made of a wire or a thread, and the conductive material comprises a metal.

25. The information carrying card of claim 20, wherein the conductive material is made of copper or copper alloy.

26. A method of making one or a plurality of the information carrying cards according to claim 20, comprising:
making the core layer comprising a plurality of sections.

27. A method of claim 26, wherein the making the core layer comprises:
forming the core sheet on the substrate film;
applying a crosslinkable polymer composition in a liquid or paste form to both sides of the core sheet in a press for lamination; and
curing the crosslinkable polymer composition through heating and/or radiation under a pressure so as to form the core layer, wherein the crosslinkable polymer composition is converted into the crosslinked polymer composition.

28. The method of claim 26, wherein the conductive material in the antenna structure is applied on the substrate film through vapor deposition, printing, or cladding technique, or any combination thereof.
